(19) United States
(12) Patent Application Publication
(10) Pub. No.: US 2006/0157289 A1
(43) Pub. Date: Jul. 20, 2006

(54) Touch panel

(75) Inventor: Chia-Chi Chou, Taipei (TW)

Correspondence Address: BACON & THOMAS, PLLC, 625 SLATERS LANE, FOURTH FLOOR, ALEXANDRIA, VA, 22314, US

(73) Assignee: Advanced Touch Optics Technology Corporation, Taipei Hsien (TW)

(21) Appl. No.: 11/333,277

(22) Filed: Jan. 18, 2006

(30) Foreign Application Priority Data
Jan. 18, 2005 (TW) 094200902

(51) Int. Cl. G08C 21/00

(52) U.S. Cl. 178/18.01

(57) ABSTRACT

An improved touch panel is disclosed. The touch panel according to the invention comprises a transparent substrate, a first transparent insulative sheet joined to the transparent substrate to form a first gap therebetween, a second transparent insulative sheet joined to the first transparent insulative sheet to form a second gap therebetween, a first transparent conductive film formed over the transparent insulative sheet within the second gap, and a second transparent conductive film formed over the second transparent insulative sheet within the second gap. Furthermore, a first anti-Newton ring film can be formed over the first transparent insulative sheet within the first gap, and a second anti-Newton ring film can be formed between the second transparent conductive film and the second transparent insulative sheet.

### BACKGROUND OF THE INVENTION

1. Field of the Invention

The invention relates to touch panel techniques, and more particularly, to an improved touch panel.

2. Description of the Related Art

A touch panel generally integrates a liquid crystal panel or a cathode ray tube (CRT) monitor as an input interface for a user. That is, a user is enabled to perform operations including moving a cursor and clicking on an icon by touching the panel.

Referring to FIGS. 1A and 1B showing sectional schematic views of a conventional F/G (film-on-glass) touch panel 1. The F/G touch panel 1 comprises a glass substrate 10 and an insulative sheet 12. The glass substrate 10 can be made of a non-alkali glass, and the insulative sheet can be made of a polyester (PET) sheet. With reference to FIG. 1, an indium tin oxide (ITO) layer 11 is covered on a surface of the glass substrate 10, and another ITO layer 13 is covered on a surface of the insulative sheet 12. The glass substrate 10 is joined with the insulative sheet 12 using adhesion material 15, such that the ITO layer 11 at the glass substrate 10 faces the ITO layer 13 at the insulative sheet 12. In addition, to ensure a certain distance between the ITO layers 11 and 13 to prevent short circuits, a plurality of spacers 14 are generally placed on the ITO layer 11 at the glass substrate 10.

For that the insulative sheet 12 is a flexible material, the insulative sheet 12 is prone to bending downwards when not being appropriately joined with the glass substrate 10 as shown in FIG. 1B. An area of bending of the insulative sheet 12 often occurs near a central region 16, which incurs Newton ring effects due to diffraction.

Referring to FIG. 2 showing a sectional schematic view of a conventional F/F/P (film-to-film-on-plastic) touch panel, an F/F/P touch panel 2 comprises a plastic substrate 20 and two insulative sheets 22 and 24. The plastic substrate 20 can be made of acrylic or polycarbonate (PC), and the insulative sheets 22 and 24 can be made of PET sheets or other plastic thin-film sheets such as PC, ARTON and ZEONOR. With reference to FIG. 2A, an ITO layer 23 is covered on a surface of the insulative sheet 22, and another ITO layer 25 is covered on a surface of the insulative sheet 24. As shown in FIG. 2, the plastic substrate 20 is wholly joined to the insulative 22 using an adhesion layer 21, and the other insulative sheet 22 is joined with the insulative sheet 24 using an adhesion material 26, such that the ITO layer 23 at the insulative sheet 22 faces the ITO layer 25 at the insulative sheet 24. In addition, to ensure a certain distance between the ITO layers 23 and 25 to prevent short circuits, a plurality of spacers 27 is generally placed on the ITO layer 23 at the insulative sheet 22.

Because the adhesion layer 21 is wholly applied to and located between the plastic substrate 20 and the insulative 22, impurities or bubbles are likely formed at the adhesion layer 21 to lead to unsatisfactory yield rates. Moreover, for that the insulative sheet 24 is a flexible material, the insulative sheet 24 is prone to bending downwards when not being appropriately joined, and an area of bending often occurs near a central region 28, which incurs Newton ring effects due to diffraction.

### SUMMARY OF THE INVENTION

It is therefore an object of the invention to provide a novel touch panel capable of preventing impurities or bubbles in an adhesion material that leads to unsatisfactory yield rates.

It is another object of the invention provide a novel touch panel capable of eliminating Newton ring effects.

To accomplish the aforesaid objects, the invention provides a touch panel. A touch panel according to the invention comprises a transparent substrate; a first transparent insulative sheet joined to the transparent substrate to form a first gap therebetween; a second transparent insulative sheet joined to the first transparent insulative sheet to form a second gap therebetween; a first transparent conductive film formed over the transparent insulative sheet within the second gap; and a second transparent conductive film formed over the second transparent insulative sheet within the second gap.

The invention also provides another touch panel to accomplish the aforesaid objects. Another touch panel according to the invention comprises a transparent substrate; a first transparent insulative sheet joined to the transparent substrate to form a first gap therebetween; a second transparent insulative sheet joined to the first transparent insulative sheet to form a second gap therebetween; a first transparent conductive film formed over the first transparent insulative sheet within the first gap; a second transparent conductive film formed over the second transparent insulative sheet within the second gap; a first anti-Newton ring film formed over the first transparent insulative sheet within the first gap; and a second anti-Newton ring formed between the second transparent conductive film and the second insulative sheet.

To better understand characteristics, effects, functions and objects of the invention, detailed descriptions of a preferred embodiment shall be given with the accompanying drawings below.

### BRIEF DESCRIPTION OF THE DRAWINGS

FIGS. 1A and 1B show sectional schematic views of a prior F/B touch panel;

FIG. 2 shows a sectional schematic view of a prior F/F/P touch panel;

FIG. 3 shows a sectional schematic view of a touch panel in a preferred embodiment according to the invention; and

FIG. 4 shows a sectional schematic view of a touch panel in another preferred embodiment according to the invention.

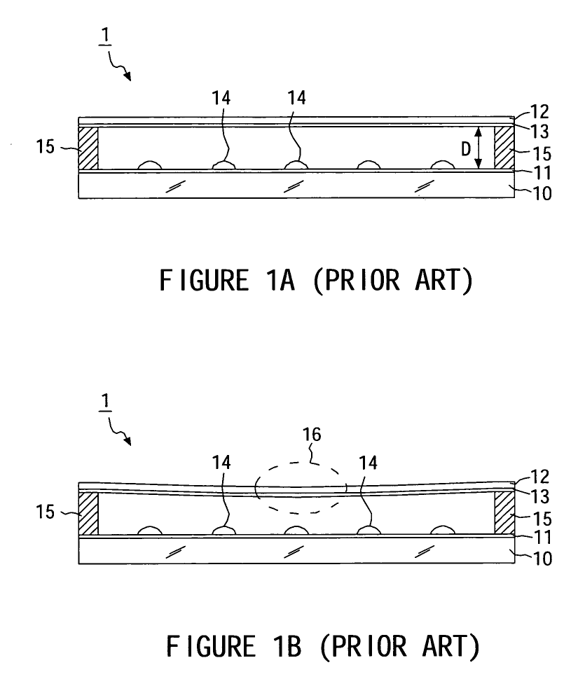

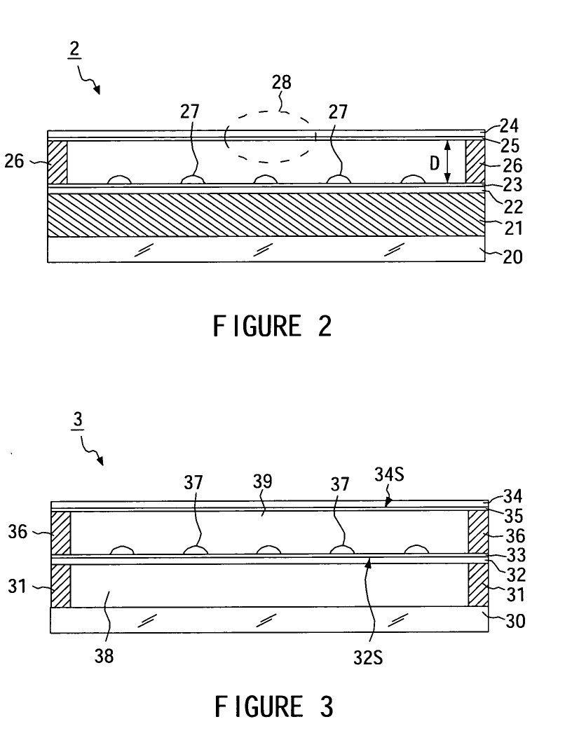

### DETAILED DESCRIPTION OF THE PREFERRED EMBODIMENTS

Referring to FIG. 3 showing a sectional schematic view illustrating a touch panel 3 in accordance with a preferred embodiment of the invention, the touch panel 3 comprises a transparent substrate 30 and two transparent insulative sheets 32 and 34. The transparent substrate 30 can be made of plastic, acrylic, glass or PC materials, and the insulative sheets 32 and 34 can be made of PET sheets or other plastic thin-film sheets such as PC, ARTON and ZEONOR. With reference to FIG. 3, a first transparent conductive film 33 is covered on a surface 32S of the insulative sheet 32, and a second transparent conductive film 35 is covered on a surface 34S of the insulative sheet 34. Wherein, the first transparent conductive film 33 and the second transparent conductive film 35 can be made of conductive material such as ITO.

Again referring to FIG. 3, the transparent substrate 30 is joined with the transparent insulative sheet 32 using an adhesion material 31. The adhesion material 31 is merely disposed at peripheral regions of the transparent substrate 30 and the transparent insulative sheet 32, and thus a gap 38 is formed between the transparent substrate 30 and the transparent insulative sheet 32, with the gap 38 being filled with a gas or in a vacuum state. The transparent insulative sheet 32 is joined with the insulative sheet 34 using an adhesion material 36, such that the transparent conductive film 33 at the transparent insulative sheet 32 faces the second transparent conductive film 35 at the transparent insulative sheet 34. The adhesion material 36 is merely disposed at peripheral regions of the transparent insulative sheet 32 and the transparent insulative sheet 34, and thus a gap 39 is formed between the transparent insulative sheets 32 and 34, with the gap 39 being filled with a gas or in a vacuum state. In addition, to ensure a certain distance between the transparent conductive films 33 and 35 to prevent short circuits, a plurality of spacers 37 is generally placed on the first transparent conductive film 33 at the insulative sheet 32.

Accordingly, the adhesion material 31 at the touch panel shown in FIG. 3 is merely disposed at peripheral regions of the transparent substrate 30 and the transparent insulative sheet 32 instead of being wholly applied. Therefore, even if impurities or bubbles are formed in the adhesion material 31, an issue of unsatisfactory yield rates is eliminated.

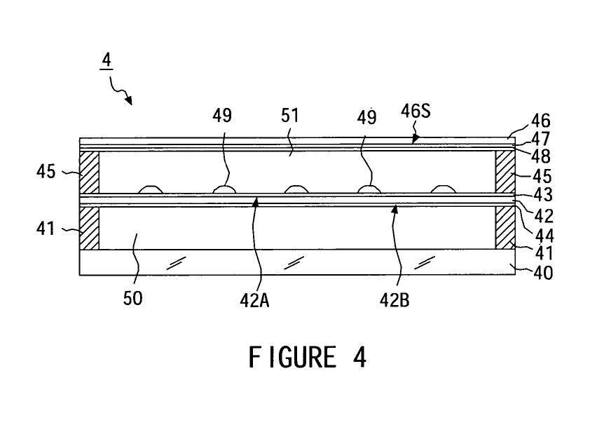

Referring to FIG. 4 shows a sectional schematic view illustrating a touch panel 4 in accordance with another preferred embodiment of the invention, the touch panel 4 comprises a transparent substrate 40 and two transparent insulative sheets 42 and 46. The transparent substrate 40 can be made of plastic, acrylic or glass materials, and the insulative sheets 42 and 46 can be made of PET sheets. With reference to FIG. 4, a first transparent conductive film 43 is covered on a surface 42A of the transparent insulative sheet 42, and a first anti-Newton ring film 44 is covered on another surface 42B of the transparent insulative sheet 42. A second anti-Newton ring film 47 is covered on a surface 46S of the transparent insulative sheet 46, and a second transparent conductive film 48 is covered on the second anti-Newton ring film 47. The first transparent conductive film 43 and the second transparent conductive film 48 can be made of ITO, and the first anti-Newton ring film 44 and the second anti-Newton ring film 47 can be made of acrylic or silicon dioxide polymer materials.

Again referring to FIG. 4, the transparent substrate 40 is joined with the transparent insulative sheet 42 using an adhesion material 41 such that the first anti-Newton ring film 44 faces the transparent substrate 40. The adhesion material 41 is merely disposed at peripheral regions of the transparent substrate 40 and the transparent insulative sheet 42, and thus a gap 50 is formed between the transparent substrate 40 and the transparent insulative sheet 42, with the gap 50 being filled with a gas or in a vacuum state. The transparent insulative sheet 42 is joined with the insulative sheet 46 using an adhesion material 45, such that the first transparent conductive film 43 at the transparent insulative sheet 42 faces the second transparent conductive film 48 at the insulative sheet 44. The adhesion material 45 is merely disposed at peripheral regions of the transparent insulative sheets 42 and 46, and thus a gap 51 is formed between the transparent insulative sheets 42 and 46, with the gap 51 being filled with a gas or in a vacuum state. In addition, to ensure a certain distance between the transparent conductive films 43 and 48 to prevent short circuits, a plurality of spacers 49 is generally placed on the first transparent conductive film 43 at the insulative sheet 42.

Accordingly, the adhesion material 41 at the touch panel shown in FIG. 4 is merely disposed at peripheral regions of the transparent substrate 40 and the transparent insulative sheet 42 instead of being wholly applied. Therefore, even if impurities or bubbles are formed in the adhesion material 41, an issue of unsatisfactory yield rates is eliminated. Furthermore, the first anti-Newton ring film 44 and the second anti-Newton ring 47 are respectively formed at the surface 42A and of the transparent insulative sheet 42 and at the surface 46S of the transparent insulative sheet 46, and therefore Newton ring effects can be prevented.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A touch panel, comprising:
a transparent substrate;
a first transparent insulative sheet joined to said transparent substrate to form a first gap therebetween;
a second transparent insulative sheet joined to said first transparent insulative sheet to form a second gap therebetween;
a first transparent conductive film formed over said first transparent insulative sheet within said second gap; and
a second transparent conductive film formed over said second transparent insulative sheet within said second gap.

2. The touch panel as claimed in claim 1, further comprising a first anti-Newton ring film formed over said first transparent insulative sheet within said first gap.

3. The touch panel as claimed in claim 1, further comprising a second anti-Newton ring film formed between said second transparent conductive film and said second transparent insulative sheet.

4. The touch panel as claimed in claim 1, wherein said transparent substrate is selectively from a group consisting of plastic, acrylic, glass and PC materials.

5. The touch panel as claimed in claim 1, wherein said first transparent insulative sheet is selectively from a group consisting of PET, PC, ARTON, and ZEON materials.

6. The touch panel as claimed in claim 1, wherein said second transparent insulative sheet is selectively from a group consisting of PET, PC, ARTON, and ZEON materials.

7. The touch panel as claimed in claim 1, wherein said first transparent conductive film and said second transparent conductive film are made of indium tin oxide (ITO) films.

8. The touch panel as claimed in claim 1, further comprising a plurality of spacers formed on said first transparent conductive film.

9. A touch panel, comprising:
a transparent substrate;
a first transparent insulative sheet joined to said transparent substrate to form a first gap therebetween;
a second transparent insulative sheet joined to said first transparent insulative sheet to form a second gap therebetween;
a first transparent conductive film formed over said first transparent insulative sheet within said second gap;
a second transparent conductive film formed over said second transparent insulative sheet within said second gap;
a first anti-Newton ring film formed over said first transparent insulative sheet within said first gap; and
a second anti-Newton ring film formed between said second transparent conductive film and said second transparent insulative sheet.

10. The touch panel as claimed in claim 9, wherein said transparent substrate is selectively from a group consisting of plastic, acrylic, glass and PC materials.

11. The touch panel as claimed in claim 9, wherein said first transparent insulative sheet is selectively from a group consisting of PET, PC, ARTON, and ZEON materials.

12. The touch panel as claimed in claim 9, wherein said second transparent insulative sheet is selectively from a group consisting of PET, PC, ARTON, and ZEON materials.

13. The touch panel as claimed in claim 9, wherein said first transparent conductive film and said second transparent conductive film are made of indium tin oxide (ITO) films.

14. The touch panel as claimed in claim 9, further comprising a plurality of spacers formed on said first transparent conductive film.
